(19) United States
(12) Patent Application Publication
(10) Pub. No.: US 2007/0028018 A1
(43) Pub. Date: Feb. 1, 2007

(54) Stand-alone bluetooth adapter for computer peripherals, master usb. bluetooth. adapter and communication system

(75) Inventors: Olivier Giroud, Paris (FR); Thomas Serval, Neuilly Sur Seine (FR)

Correspondence Address: YOUNG & THOMPSON, 745 SOUTH 23RD STREET, 2ND FLOOR, ARLINGTON, VA, 22202, US

(73) Assignee: BARACODA, Paris (FR)

(21) Appl. No.: 10/545,447

(22) PCT Filed: Feb. 13, 2004
(86) PCT No.: PCT/FR04/50059

§ 371 Date: May 12, 2006

(30) Foreign Application Priority Data
Feb. 14, 2003 (FR) 03/50026

(51) Int. Cl. G06F 13/38

(52) U.S. Cl. 710/62

(57) ABSTRACT

A radio communication adapter box (1,11) for data exchange computer link between a first master-type computer equipment and at least one second peripheral-type computer equipment, the box being connected to at least one second computer equipment. The adapter includes a radio transmission/reception module (2) according to the Bluetooth® protocol with a Bluetooth® protocol stack, at least one interface controller with wire link connector towards at least one second equipment and a stand-alone electro-chemical power supply source (5), the power supply source (5) feeding at least one second equipment. The invention also relates to an adapter as well as a communication system for computer data exchange are also disclosed.

The present invention relates to a stand-alone Bluetooth® adapter for computer peripherals. It also relates to a master USB® Bluetooth® adapter as well as a communication system. It finds applications in the computer field and notably the connection of peripheral equipment to other pieces of equipment via a Bluetooth® radio link.

The application FR01/04659 or its extension PCT/FR02/01202 divulges a radio communication module according to the Bluetooth® protocol, also denominated SMARTMODULE, having software capabilities enabling it to operate one or several on-board user applications in the module in order to confer a Bluetooth® functionality thereto. This module which exhibits inputs/outputs intended to be connected to electronic circuits of the application, also includes software resources facilitating the development of user applications and hardware interfacing. It will be appreciated that such a module may be employed within the framework of the invention.

In addition to computer wire-type connection means between a computer and a parallel type peripheral (printer) or PS2, RS232, RS422 or RS485 series peripheral, the USB® protocol is also known, which enables to connect pieces of computer equipment together over a series wire-type link to enable data exchanges. Such link enables, besides, from a master type USB® connector, such as those installed in the micro-computers, to feed peripherals over the wire-type link. Such protocol requires relatively significant software resources and it generally involves specialised electronic circuits, notably integrated dedicated circuits, in order to relieve the computer equipment from certain software constraints of the USB protocol. These electronic circuits are generally microcontrollers programmed to handle low-order software aspect of the USB® protocol and interfacing with the pieces of equipment. These microcontrollers provide advantageously a temporary storage memory, a transmission or reception memory stack, enabling to optimise exchanges with the equipment. They may also comprise means for regulating and/or controlling the power supply of the USB® link. It is thus that the circuits of the EZ-USB® family, manufactured by Anchor Chips Incorporated may be mentioned, which enable to add USB® inputs/outputs to computer equipment or those manufactured by Prolific Technology Inc or, finally, the FT8U232AM circuit, manufactured by FTDI, which is a USB®-RS232 adapter.

The USB® links have a defect of requiring a physical wiring which, moreover, should implement materials exhibiting certain qualities, notably for cables, efficient shielding, low losses . . . which involves relatively high cost with respect to other links and limits the distance between two pieces of equipments connected.

Besides, the radio adapters known between a master equipment, notably micro-computer, and a peripheral equipment, for instance a printer, are essentially intended to replace the conventional wire link between both these pieces of equipment in order to solve the wiring problems between several pieces of equipment.

The present invention provides a stand-alone Bluetooth® radio adapter with integrated power supply in the form of a box connected to one or several peripherals and which limits the constraints imposed by the wire links (wiring) while enabling electric power supply of the peripheral(s). In a particular embodiment, the peripheral(s) are of USB® type connection and the adapter is of Bluetooth® USB® master type

The invention hence relates to a radio communication adapter box for data exchange computer link between a first master-type computer equipment and at least one second peripheral-type computer equipment, the box being connected to said at least one second computer equipment.

According to the invention, the adapter includes a radio transmission/reception module according to the Bluetooth® protocol with a Bluetooth® protocol software stack, at least one interface controller with wire link connector towards said at least one second equipment and a stand-alone electro-chemical power supply, the power supply source feeding said at least one second equipment.

It should be understood at this stage that the expression wire link corresponds to a cable connection as well as a connector-to-connector direct link. Consequently, the adapter is connected directly by its connector to the connector of the peripheral or a link cable links the connector of the adapter to the connector of the peripheral or that the connector of the box is at the end of a link cable towards the peripheral or that the connector of the peripheral is at the end of a link cable towards the box.

In various embodiments of the invention, the following means which may be used individually or according to all the technically possible combinations, are employed:
the radio transmission/reception module according to the Bluetooth® protocol with a Bluetooth® protocol software stack is a SMARTMODULE,
a connector on the box is connected directly to a connector of the second computer equipment,
the box is connected over a wire link to a connector of the second computer equipment, the connector of the box being at the end of the wire link towards the second computer equipment,
a connector on the box is connected to a wire link from the second computer equipment,
the adapter is connected over a wire link between a connector on the box and a connector of the second computer equipment,
the adapter includes at least one interface controller with USB® type series wire link connector, PS2, RS232, RS422 or RS485 for the exchange of data,
the adapter includes at least one interface controller with wire link parallel connector for the exchange of data,
the parallel connector is of Centronics® type,
the stand-alone electro-chemical power supply feeds said at least one second equipment via at least one box-mounted power supply connector connected to said at least one second equipment via power supply wire link, the box-mounted power supply connector being distinct from the data exchange connector,
the stand-alone electro-chemical power supply feeds said at least one second equipment via the connector and, notably in the case of a USB® series link, via said USB® connector of the box,
the stand-alone electrochemical power supply is a rechargeable battery,
the adapter includes a battery charging connector,
the adapter includes moreover a battery charging regulation circuit,
the battery is removable,
in the case of an interface controller with USB® type series wire link connector, the adapter includes means for charging the battery by dint of a USB® connector of the box,
in the case of an interface controller with USB® type series wire link connector, the interface controller is of USB® master software stack type,
the adapter includes moreover an interface distribution functionality of the same type or of different types between several data exchange connectors,
the adapter is stand-alone and mobile,
the adapter includes means for being carried by a user of the second computer equipment.

The invention also relates to a Bluetooth® adapter USB® for computer peripherals with USB® interface socket intended for computer data exchanges, wherein the adapter includes a radio transmission/reception module according to the Bluetooth® protocol with a Bluetooth® protocol stack, at least one USB® interface controller with link connector towards said computer peripheral and a stand-alone electro-chemical power supply, the USB® interface controller containing a USB® master type software stack and the power supply source feeding said computer peripheral.

The invention finally relates to a radio communication system for computer data exchanges between a master computer equipment, notably a micro-computer, and at least one peripheral computer equipment wherein a step of data exchanges takes place over a radio channel according to the Bluetooth® protocol, a stand-alone Bluetooth® adapter box according to one or several of the features listed previously being arranged between the radio channel and the peripheral computer equipment, said Bluetooth® adapter containing a radio transmission/reception module according to the Bluetooth® protocol with a Bluetooth® protocol software stack, at least one interface controller with wire link connector towards said peripheral computer equipment and a stand-alone electro-chemical power supply, the power supply source feeding said peripheral computer equipment, an Bluetooth® interface being moreover arranged between the radio channel and the master computer equipment, said Bluetooth® interface being fed by the master computer equipment and containing a radio transmission/reception module according to the Bluetooth® protocol, a Bluetooth® protocol software stack being arranged in the master computer equipment.

In particular modalities of the system which may be combined according to all the technically possible modalities:
the peripheral computer equipment includes a USB® input/output and the box includes at least one interface controller with USB® wire link connector, the peripheral computer equipment and the box being connected by the USB® wire link, the power supply of the peripheral computer equipment coming from the stand-alone electro-chemical power supply of the box,
the Bluetooth® interface arranged between the radio channel and the master computer equipment include moreover USB® software and hardware linking means, the data transiting via the USB® interface, then the Bluetooth® interface of the master computer equipment towards the peripheral in a first transfer direction and, reversely, in an opposite transfer direction,
the box includes hardware and software series linking means (notably USB®, PS2, RS232, RS422 or RS485) and/or parallel linking means towards the peripheral computer equipment.

The present invention will now be exemplified without being limited thereto with the following description in relation to the Figures below:

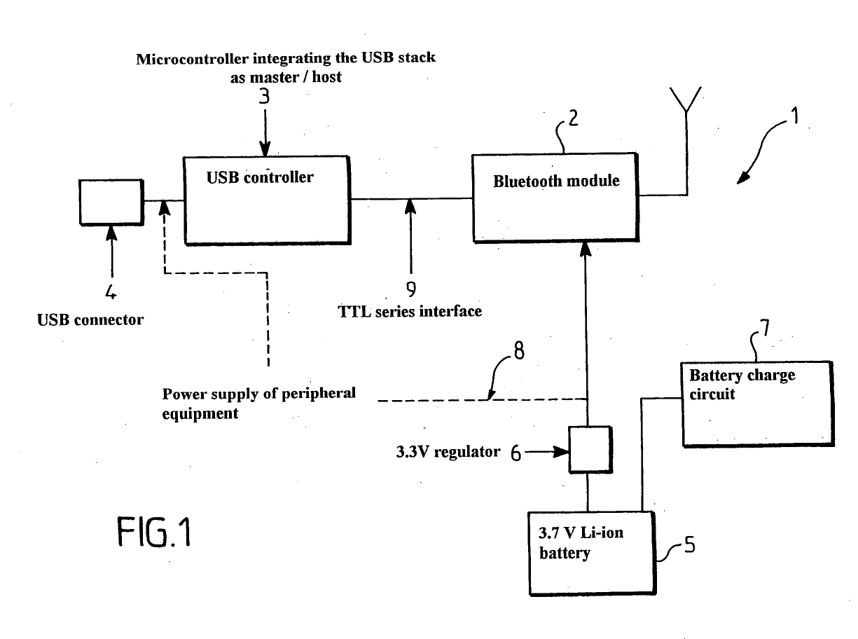

FIG. 1 which represents an adapter according to the invention,

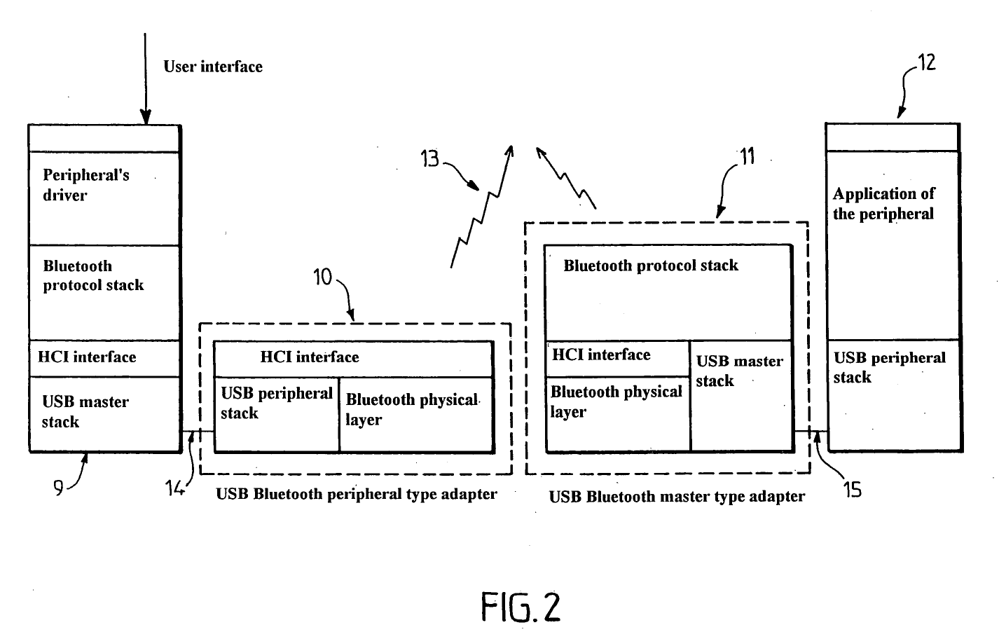

FIG. 2 which represents a distribution pattern of the operational functions in a generic application of the invention with USB® type master and, for comparison purposes, of a USB® type peripheral adapter.

The examples given correspond mainly to a version of the adapter as a whole or of the adapter box which includes USB® type master means towards the peripheral computer equipment. However, the invention in its entirety corresponds to a Bluetooth® stand-alone adapter feeding the peripheral and whereof the data link to the peripheral may be of diverse types, notably series and/or parallel, and more precisely with a single or multiple link of the same type or of different types. Thus, in a particular embodiment version, the adapter or the adapter box may contain a USB® master type data link associated with one or several other series links (among which USB®) and/or parallel links. In all cases, the interface controller(s) of the adapter or adapter box correspond to the type of link to establish with the peripheral computer equipment.

In the case of a USB® link, the power supply of the peripheral by the adapter or the adapter box takes place via the USB® connector. In other types of wire link, the power supply may take place either via the data link connector, for instance for a RS232 link, the control signals, notably DTR, may enable the power supply of a low-consumption peripheral (a few milliamperes), or via specific power supply wire link in parallel of the data wire link.

The adapter 1 of FIG. 1 includes a Bluetooth® transmission/reception module 2 according to said protocol with, schematised on the right, an antenna, on the left a series type link 9 for data exchange with a USB® electronic circuit controller, itself linked to a USB® connector 4 intended for connection to a computer peripheral via USB wire link or directly into a USB® socket of said peripheral. The module 2 is supplied with 3.3V by a regulator 6 connected to a 3.7V Lithium-ion battery 5, which may be recharged by dint of a battery charging circuit 7. The battery is a battery used conventionally in mobile telephony and it has high volume capacity, enabling to realise small-volume adapter. Besides, the battery charging circuit may be added on to an external power supply block, which may be left connected permanently in the case of a fixed usage of the adapter. The link 9 between the USB® controller 3 and the Bluetooth® module 2 accepts the TTL logic levels or, preferably, its low-consumption variations, such as for instance HCT.

The USB® controller 3 includes a dedicated microcontroller which is configured as master (HOST) and which integrates hence, as will be seen in relation to FIG. 2, a master protocol stack. In this example, the power supply of the USB® connector 4 is regulated and taken at output of the 3.3V regulator. However, if the USB® controller 3 includes integrated means for controlling the power supply for the USB® connector, said means will be used, which may moreover enable to measure the intensity of the current sent over the USB® link. The module 2 includes hardware and software resources enabling to operate specific user applications and in particular means for tracking and controlling the power supply of the module in order, at least, on the one hand to signal the low level of the battery and, on the other hand, to prevent excessive discharge of the battery by placing the adapter in standby mode. The adapter of FIG. 1 may also include means for charging the battery (not represented) via the USB® connector.

FIG. 2 represents two USB® Bluetooth® adapters side by side the better to put in evidence the specificities of the USB® Bluetooth® master type adapter of the invention 11 (on the right) with respect to a peripheral type USB® Bluetooth® adapter 10, also called slave-type adapter, (on the left). The utilisation of a radio stage radio 13 according to the Bluetooth® protocol in data exchanges between the pieces of computer equipment enables to dispense with a wire-type link between said equipments.

On the left portion of FIG. 2, a conventional master computer equipment 9, for instance a micro-computer, includes typically from its user interface going towards the adapter: a peripheral driver (for instance a modem or a printer), a Bluetooth® protocol stack, an HCI interface or host controller Interface and a USB® master software stack to which is linked physically, over a USB® wire link 14, a USB® Bluetooth® peripheral type adapter 10 with its USB® software stack peripheral and the Bluetooth® physical layer with its radio means, the latter assembly being topped with an HCI interface compatible with that of the computer equipment 9. The USB® Bluetooth® peripheral type adapter 10 is fed by the master computer equipment 9 by dint of the USB® link. The driver of the peripheral enables notably to shape the messages to be transmitted according to the type of peripheral and for instance, for a printer, while replacing a word processor command with a sequence of escape characters corresponding to the command for the peripheral. The Bluetooth® protocol stack enables to encapsulate the message and to handle the radio transmission layer. The USB® Bluetooth peripheral type adapter 10 is a device which is generally in the form of a dongle.

Conversely, on the right-hand section of FIG. 2, a conventional peripheral computer equipment 12, for instance a modem or a printer or a barcode reader, possibly even a micro-computer, includes typically from the peripheral software application going towards the adapter: a (software) application of the peripheral and a USB® software stack peripheral to which is connected physically via a USB® link 15 a USB® Bluetooth master type adapter 11 with its USB® master software stack, a Bluetooth® physical layer with its radio means and an HCI interface, such assembly being topped with a Bluetooth® protocol stack. The USB® master stack enables to emulate a piece of master equipment in the adapter 11. Between the USB® Bluetooth® peripheral type adapter 10 and the USB® Bluetooth® master type adapter 11 of the invention, the exchanges are made via radio waves.

The USB® Bluetooth master type adapter 11 of the invention, as for instance realised according to FIG. 1, stands out from conventional adapters connected to the peripherals since the latter have no master type functionalities. This USB® Bluetooth master type adapter 11 enables to simulate functionalities of a piece of master equipment such as a micro-computer but on the peripheral side of the radio section of the link.

The USB® Bluetooth® adapter 11 of the invention possesses, due to this master type functionality, a stand-alone power supply source which enables moreover to feed its own USB® connector and the peripheral USB® to which it is connected. This power supply source is a rechargeable battery which is recharged thanks to a mains charger (like a car's or other) linked to a recharge connector of the adapter 1, 11 and/or, alternately or additionally, via its own USB® socket when for recharging, the adapter is connected to a master computer equipment, notably a micro-computer, whereof the USB® socket includes a power supply of the wire link. It should be understood that in the latter case, of recharging via the USB® socket of the adapter 11, said adapter is not operational from the viewpoint of data exchange since its software means (stacks . . . ) are not suited for connection with such a piece of master computer equipment.

Preferably, a charge regulation circuit (surveillance of the temperature, of the evolution of the voltage and/or current and/or voltage regulation relative to the type of battery: Pb, CdNi, Li-ion . . . ) is incorporated into the adapter to enable certain degree of freedom regarding the selection of electric power supply via the recharge connector. Preferably, the battery is a removable box containing a set of individual battery elements connected together and for instance a battery of the type of those used in mobile telephones. It may even be contemplated that in an enhanced version, the charge regulation circuit is incorporated into the box containing the individual battery elements to prevent the device from choosing means of implementation for the regulation of the charge relative to the type of battery, the regulation circuit in the box being directly suited to the elements to be recharged.

In the examples given, the case observed relates to a single adapter, i.e. it receives and transmits data between a Bluetooth® radio channel and an input/output USB®. It is also possible, in more enhanced versions, to have several master type USB® connectors on the adapter by adding a distribution functionality of USB® inputs/outputs and/or, still, other types, notably series (PS2, RS232, RS422, RS485) or parallel, in the adapter.

In a particular embodiment, the adapter is situated in a box containing a rechargeable battery, the Bluetooth® module, an electronic component for adapting the link protocol to the peripheral equipment (RS232, RS485 converter, master USB, PS2). This box may be connected to fixed peripheral equipment, for instance a printer or a badge reader (entry check-in). However, the adapter in the box being stand-alone, it will be applied more especially to mobile activities. Thus, the box, in a mobile application, may be attached to an operator's belt or to a vehicle, for instance, for stock management or handling orders in a warehouse, the box being connected over a USB® wire (wire or directly connector-to-connector) to a barcode reader. This box, in such a mobile application, may also be arranged in a carrier's truck linked for example to a chip card reader during payment operations or a barcode reader+keypad and display for deliveries. It enables any wire-type peripheral equipment, notably mobile in corresponding applications, and having a PS2 or a series (RS232, RS422 or RS485) or, still USB® (as a peripheral) interface, wireless connection over Bluetooth® to remote equipment without changing hardware nor involving the implementation of specific connection wire link with the remote equipment.

Thanks to the battery, the box generates the power supply of the peripheral via the USB® socket as well as for the Bluetooth® module properly speaking. The adapter with its Bluetooth® link forms a gateway between the peripheral equipment and a remote Bluetooth equipment, of personal computer type (PC), fixed or portable, personal digital assistant (PDA) or, even, an access point to a network (internal like INTRANET or external like INTERNET). The pieces of peripheral equipments which are usable are notably: a barcode reader, an electronic tag reader (<<RF Tag >>), a computer or micro-computer properly speaking, an industrial machine, an automaton, a sales point terminal or a payment terminal.

1. A radio communication adapter box (1,11) for data exchange computer link between a first master-type computer equipment and at least one second peripheral-type computer equipment, the box being connected to said at least one second computer equipment, characterised in that the adapter includes a radio transmission/reception module (2) according to the Bluetooth® protocol with a Bluetooth® protocol software stack, at least one interface controller with wire link connector towards said at least one second equipment and a stand-alone electro-chemical power supply (5), the power supply source (5) feeding said at least one second equipment.

2. An adapter according to claim 1, characterised in that the adapter includes at least one interface controller with USB®, PS2, RS232, RS422 or RS485 type wire link series connector for the exchange of data.

3. An adapter according to claim 1, characterised in that the adapter includes at least one interface controller with wire link parallel connector for the exchange of data.

4. An adapter according to claim 2, characterised in that the stand-alone electro-chemical power supply source (5) feeds said at least one second equipment via at least one box-mounted power supply connector connected to said at least one second equipment via power supply wire link, the box-mounted power supply connector being distinct from the data exchange connector.

5. An adapter according to claim 2, characterised in that the stand-alone electro-chemical power supply source (5) feeds said at least one second equipment via the connector and, notably in the case of a USB® series link, via said USB® connector of the box.

6. An adapter according to claim 1, characterised in that the stand-alone electro-chemical power supply source (5) is a rechargeable battery.

7. An adapter according to claim 6, characterised in that it includes moreover a battery charging regulation circuit.

8. An adapter according to claim 6, characterised in that the battery is removable.

9. An adapter according to claim 2 in the case of an interface controller with USB® type series wire link connector, characterised in that the interface controller is of USB® master software stack type.

10. An adapter according to claim 9, characterised in that it includes moreover a interface distribution functionality of the same type or of different types between several data exchange connectors.

11. A Bluetooth® adapter according to claim 1, characterised in that it is stand-alone and mobile.

12. A Bluetooth® adapter according to claim 1, characterised in that it includes means for being carried by a user of the second computer equipment.

13. A Bluetooth® USB® adapter (1,11) for computer peripherals with USB® interface socket intended for computer data exchanges, characterised in that the adapter includes a radio transmission/reception module (2) according to the Bluetooth® protocol with a Bluetooth® protocol stack, at least one USB® interface controller with link connector towards said computer peripheral and a stand-alone electro-chemical power supply source (5), the USB® interface controller containing a USB® master type software stack and the power supply source (5) feeding said computer peripheral.

14. A radio communication system for computer data exchanges between a master computer equipment (9), notably a micro-computer, and at least one peripheral computer equipment (12),
characterised in that a step of data exchanges takes place over a radio channel (13) according to the Bluetooth® protocol, a Bluetooth® stand-alone adapter box (1,11) according to claim 1 being arranged between the radio channel (13) and the peripheral computer equipment (12), said Bluetooth® adapter box (1,11) containing a radio transmission/reception module (2) according to the Bluetooth® protocol with a Bluetooth® protocol software stack, at least one interface controller with wire link connector towards said peripheral computer equipment (12) and a stand-alone electro-chemical power supply source (5), the power supply source (5) feeding said peripheral computer equipment,
a Bluetooth® interface (10) being moreover arranged between the radio channel (13) and the master computer equipment (9), said Bluetooth® interface (10) being fed by the master computer equipment (9) and containing a radio transmission/reception module according to the Bluetooth® protocol, a Bluetooth® protocol software stack being arranged in the master computer equipment.

15. A system according to claim 14 characterised in that the peripheral computer equipment (12) includes a USB® input/output and that the box includes at least one interface controller with USB® wire link connector, the peripheral computer equipment (12) and the box being connected by the USB® wire link, the power supply of the peripheral computer equipment (12) coming from the stand-alone electro-chemical power supply source (5) of the box.

16. An adapter according to claim 2, characterised in that the adapter includes at least one interface controller with wire link parallel connector for the exchange of data.

17. An adapter according to claim 3, characterised in that the stand-alone electro-chemical power supply source (5) feeds said at least one second equipment via at least one box-mounted power supply connector connected to said at least one second equipment via power supply wire link, the box-mounted power supply connector being distinct from the data exchange connector.

18. An adapter according to claim 3, characterised in that the stand-alone electro-chemical power supply source (5) feeds said at least one second equipment via the connector and, notably in the case of a USB® series link, via said USB® connector of the box.

19. An adapter according to claim 4, characterised in that the stand-alone electro-chemical power supply source (5) feeds said at least one second equipment via the connector and, notably in the case of a USB® series link, via said USB® connector of the box.

20. An adapter according to claim 7, characterised in that the battery is removable.
